(19) United States
(12) Patent Application Publication
(10) Pub. No.: US 2010/0308736 A1
(43) Pub. Date: Dec. 9, 2010

(54) STREET LAMP SYSTEM

(75) Inventors: LUNG-YU HUNG, Chu-Nan (TW); SHAN-JU LIN, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/629,127

(22) Filed: Dec. 2, 2009

(30) Foreign Application Priority Data
Jun. 3, 2009 (CN) 200910302892.X

(51) Int. Cl. H05B 37/02

(52) U.S. Cl. 315/149; 315/307

(57) ABSTRACT

An exemplary street lamp system includes a monitoring center, a first street lamp, a first sensor, a first signal receiving unit, a first signal sending unit, and a first power management unit. The monitoring center is configured for sending a monitoring signal. The first sensor is configured for detecting an operating state of the first street lamp and generating a first detection signal. The first signal receiving unit is configured for receiving the monitoring signal. The first signal sending unit selectively operates in a power-on state where the first signal sending unit sends a feedback signal to the monitoring center based on the monitoring signal, or a power-off state where the first signal sending unit does not send the feedback signal to the monitoring center. The first power management unit is configured for switching the first signal sending unit to the power-off state in response to the first detection signal.

### BACKGROUND

1. Technical Field

The disclosure generally relates to street lamp systems, and particularly to a street lamp system capable of feeding back an operating state of a street lamp.

2. Description of Related Art

Street lamps provide much-needed illumination of traffic lanes and other outdoor areas, enhancing public convenience and safety.

Street lamps may cease to operate when malfunctioning, so public service departments should have access to as timely as possible information regarding the lamps' operating state.

What is needed, therefore, is a street lamp system which can overcome the limitations described.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the street lamp system. Moreover, in the drawings, like reference numerals designate corresponding parts throughout the several views.

FIG. 1 is a schematic view of a street lamp system, in accordance with a first embodiment.

FIG. 2 is a block diagram of the street lamp system of FIG. 1.

FIG. 3 is a block diagram of a street lamp system in accordance with a second embodiment, the street lamp system including a plurality of street lamps.

FIG. 4 is a schematic view illustrating an arrangement of the street lamps of FIG. 3 in a block.

FIG. 5 is a schematic view of a circuit connection of the street lamps in FIG. 4.

FIG. 6 is a block diagram of the street lamp system, in accordance with a third embodiment.

### DETAILED DESCRIPTION

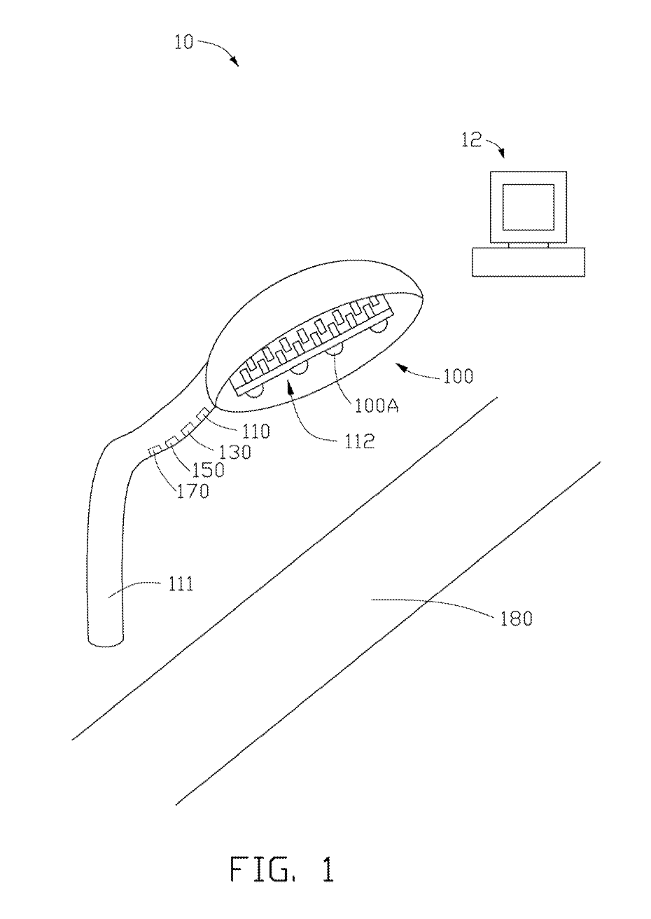

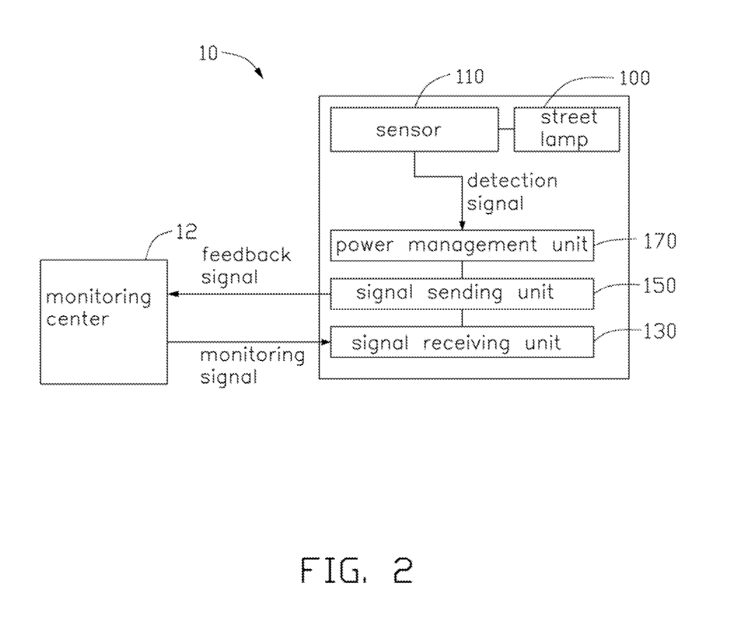

Referring to FIGS. 1 and 2, a street lamp system 10, in accordance with a first embodiment, is shown. The street lamp system 10 includes a monitoring center 12, a street lamp 100, a sensor 110, a signal receiving unit 130, a signal sending unit 150, and a power management unit 170. The street lamp 100 generally includes a lamp post 111 and an illumination device 112. The lamp post 111 is positioned adjacent to a traffic lane 180. The illumination device 112, the sensor 110, the signal receiving unit 130, the signal sending unit 150, and the power management unit 170 are each installed on the lamp post 111. The illumination device 112 may, for example, include a plurality of solid-state light sources 100A, such as light emitting diodes, providing illumination.

The sensor 110 detects an operating state of the street lamp 100. The operating state of the street lamp 100 may for example, include a working temperature of the street lamp 100, a light intensity of the street lamp 100, and other information. Accordingly, the sensor 110 can be a thermal sensor, a photo sensor, or other. In this embodiment, the sensor 110 is a photo sensor mounted on the street lamp 100 adjacent to the solid-state light source 100A. In operation, the sensor 110 detects a light intensity of the solid-state light source 100A. In an example, no detection signal is generated by the sensor 110 when the solid-state light source 100A functions normally and the sensor 110 detects a normal level of light intensity from the solid-state light source 100A. However, if the solid-state light source 100A fails to function and no light is generated, the sensor 110 generates a detection signal.

The signal receiving unit 130 receives a monitoring signal from the monitoring center 12. The monitoring center 12 may be electrically connected to the signal receiving unit 130, and may include a transmission circuit (not shown) for sending the monitoring signal. The monitoring signal may be an electrical signal. Preferably, the monitoring signal is a wireless signal and the transmission circuit is a wireless signal receiving circuit. The monitoring signal can be sent by wireless communications, such as worldwide interoperability for microwave access (WiMAX), wireless local area network (WLAN), Wi-Fi, Bluetooth or infrared signal transmission.

The signal sending unit 150 responds by sending a corresponding feedback signal. The feedback signal may be an electrical signal sent to the monitoring center 12. Alternatively, the feedback signal may be a wireless signal sent by wireless communications. When the monitoring center 12 receives the feedback signal, it is accepted that the street lamp 100 is functioning normally, that is generating illumination of normal intensity. If, however, the street lamp 100 functions abnormally, such as generating no illumination, monitoring center 12 receives no feedback signal, and it is accepted that the street lamp 100 fail to function. Specifically, the signal sending unit 150 has a power-on state and a power-off state. Electric current applied to the signal sending unit 150 in the power-on state generates the response, and thereby a corresponding feedback signal. Conversely, no electric current applied to the signal sending unit 150 results in the power-off state, and no feedback signal is generated and sent to the monitoring center 12.

The power management unit 170 is electrically connected to the sensor 110 and the signal sending unit 150, and is configured for receiving the detection signal, thereby switching the signal sending unit 150 between the power-on state and the power-off state. The power management unit 170, for example, can be a Microcontroller Unit (MCU), or a Complex Programmable Logic Device (CPLD), or another management unit.

In operation, the power management unit 170 functions initially to control the signal sending unit 150 to operate in the power-on state when no detection signal is received. If a response is sent to the signal receiving unit 130, the signal sending unit 150 responds in turn and accordingly sends a feedback signal to the monitoring center 12. When the street lamp 100 functions abnormally, a detection signal is generated by the sensor 110 to the power management unit 170. The power management unit 170 thus switches the signal sending unit 150 to the power-off state. If a response is sent to the signal receiving unit 130, the signal sending unit 150 cannot reply, and no feedback signal is received by the monitoring center 12.

In a typical application, the street lamp system 10 may include a plurality of street lamps 100, adjacent to a traffic lane 180. In operation, a plurality of responses can be sent to the street lamps 100 in sequence respectively to determine normal function. If no feedback signal is sent from at least one of the street lamps 100, the monitoring center 12 registers the non-sending street lamp(s) 100 as malfunctioning.

At intervals, the responses can be sent to the street lamps 100 in sequence respectively to determine normal function another time. If the record of the preceding malfunctioning street lamp(s) 100 operating abnormally is not deleted, the responses advance to be sent from a subsequent street lamp 100, which functions normally in the preceding time. If, however, such record is deleted, the response can be sent to the preceding malfunctioning street lamp(s) 100 again. It is noted the record of the malfunctioning street lamp(s) 100 can be deleted when such street lamp(s) 100 has/have been repaired.

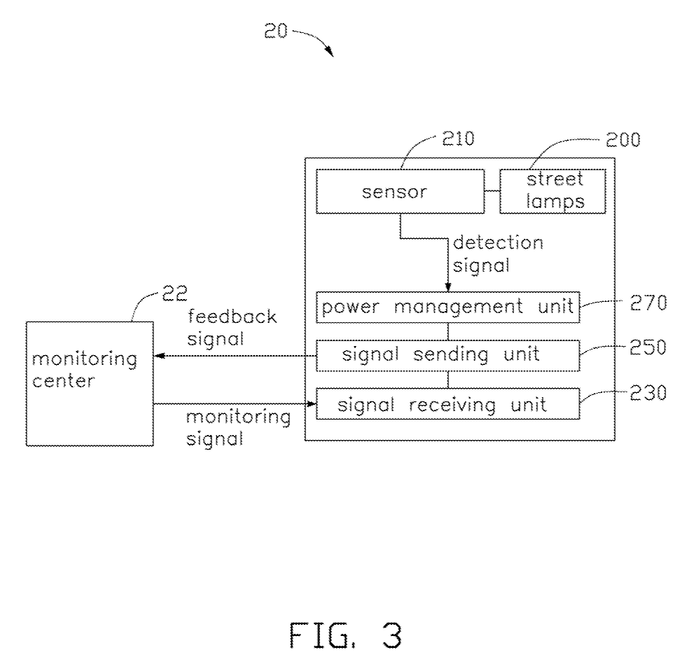

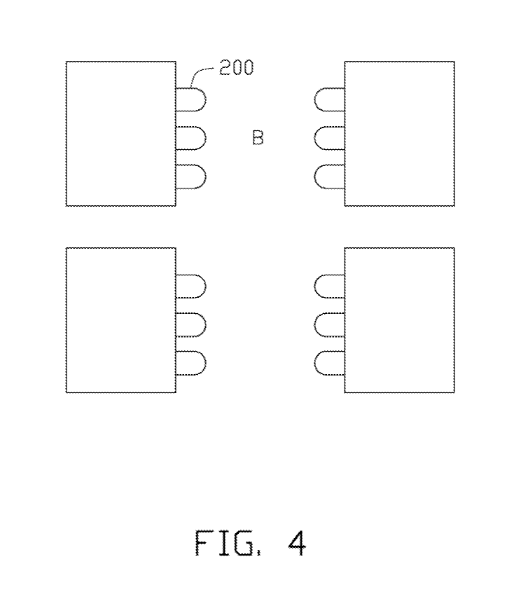

Referring to FIGS. 3 and 4, a street lamp system 20 according to a second embodiment is shown, differing from the street lamp system 10 of the first embodiment only in inclusion of a plurality of street lamps 200. In addition, the sensor 210, the signal receiving unit 230, the signal sending unit 250, and the power management unit 270 are mounted on one, or at least two different street lamps 200. Furthermore, in this embodiment, the sensor 210 is a current sensor.

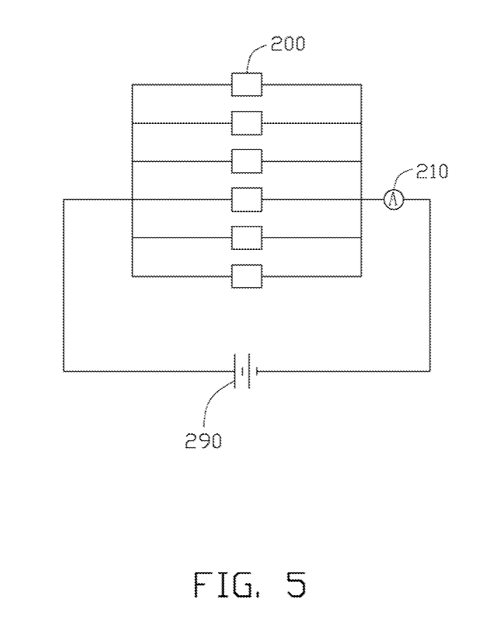

In the illustrated embodiment of FIG. 4, six street lamps 200 are provided and arranged adjacent to one another in the same block B. The six street lamps 200 are connected in series, and each of the street lamps 200 is connected in parallel to the sensor 210. A power source 290 is provided to supply electric current to each of the street lamps 200, as shown in FIG. 5. When all the street lamps 200 operate normally, no detection signal is sent to the power management unit 270. The signal sending unit 250 functions in an power-on state. If a response is sent to the signal receiving unit 230, the signal sending unit 250 accordingly sends a feedback signal to the monitoring center 22.

A current value through the sensor 210 when all the street lamps 200 operate normally can be preset as a reference value. If at least one of the street lamps 100 functions abnormally, the current value through the sensor 210 attenuates, and a detection signal is generated by the sensor 210 to the power management unit 270, which switches the signal sending unit 250 to an power-on state. If a response is sent to the signal receiving unit 230, the signal sending unit 250 cannot respond, and no feedback signal is sent to the monitoring center 22.

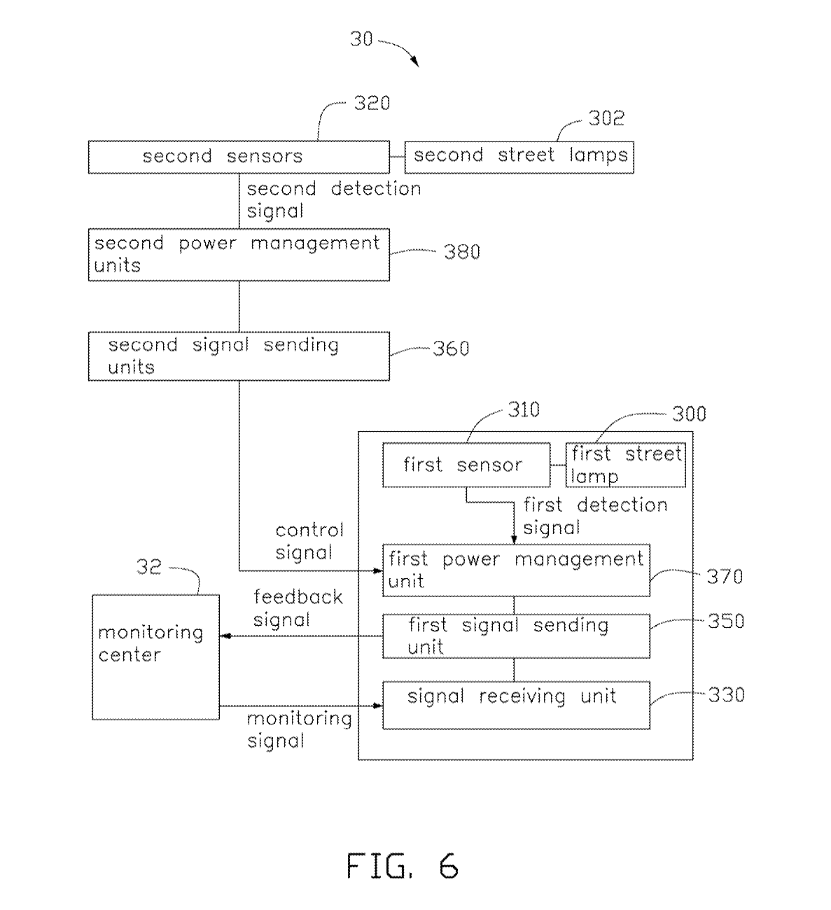

Referring to FIG. 6, a street lamp system 30 according to a third embodiment is shown. The street lamp system 30 includes a monitoring center 32, a street lamp block (not labeled), a first sensor 310, a signal receiving unit 330, a first signal sending unit 350, a first power management unit 370, a plurality of second sensors 320, a plurality of second signal sending units 360, and a plurality of second power management units 380. The street lamp block includes a first street lamp 300 and a plurality of second street lamps 302.

The first sensor 310, the signal receiving unit 330, the first signal sending unit 350, and the first power management unit 370 are each mounted on the first street lamp 300. In addition, the first sensor 310, the signal receiving unit 330, the first signal sending unit 350, and the first power management unit 370 are each similar to the sensor 310, the signal receiving unit 330, the signal sending unit 350, and the power management unit 370 respectively in principle. The first sensor 310 is a photo sensor. The first signal sending unit 350 has a first power-on state and a first power-off state. When the first street lamp 300 functions abnormally, the first sensor 310 generates a first detection signal to the first power management unit 370.

Each of the second street lamps 302 has a second sensor 320, a second signal sending unit 360, and a second power management unit 380 mounted thereon. The second sensor 320 is similar to the sensor 120 of the first embodiment in principle. The second sensors 320 each may for example be a thermal sensor or a photo sensor, or other. In this embodiment, each of the second sensors 320 is a photo sensor. In operation, each second sensor 320 detects a light intensity of the corresponding second street lamp 302. The second sensor 320 generates no detection signal when the second street lamp 302 functions normally. Conversely, the second sensor 320 generates a second detection signal when the second street lamp 302 functions abnormally. In one typical example, the second sensor 320 generates a second detection signal when a solid-state light source (not shown) of the second street lamp 302 is malfunctioning and generates no illumination.

Each second signal sending unit 360 is electrically connected to the corresponding first power management unit 370. In particular, each second signal sending unit 360 has a second power-on state and a second power-off state. The second signal sending unit 360 functions in the second power-on state to send a control signal to the first power management unit 370, which controls the first signal sending unit 350 to operate in the first power-off state. Conversely, when the second signal sending unit 360 functions in the second power-off state, no control signal is sent to the first power management unit 370.

Each of the second power management units 380 is electrically connected to the corresponding second signal sending unit 360, and is configured for receiving the second detection signal from the second sensor 320, thereby switching the second signal sending unit 360 between the second power-on state and the second power-off state. The second power management unit 380, for example, can also be a Microcontroller Unit (MCU), or a Complex Programmable Logic Device (CPLD), or other management unit.

In operation of the second street lamp system 200, the first power management unit 370 functions initially to control the first signal sending unit 350 to operate in the first power-on state when no first detection signal is received. The second power management unit 380 functions initially to control the second signal sending unit 320 to operate in the second power-off state when no second detection signal is received, and no control signal is sent to the first power management unit 370. When one of the second street lamps 302 functions abnormally, a second detection signal is generated by the corresponding second sensor 320 to the second power management unit 380. The second power management unit 380 switches the second signal sending unit 320 to the second power-on state. Accordingly, a control signal is sent by the second signal sending unit 320 to the first power management unit 370. If a response is sent to the first signal receiving unit 330, the first signal sending unit 350 cannot respond to the response, and no feedback signal is sent to the monitoring center 32.

In summary, when no first detection signal is generated by the first sensor 310, and no second detection signal is generated by any second sensor 320, the first signal sending unit 350 sends a feedback signal to the monitoring center 32. All first and second street lamps 300, 302 operate normally. Conversely, when a first detection signal is generated by the first sensor 310 or a second detection signal is generated by any of the second sensors 320, the first signal sending unit 350 cannot respond and no feedback signal is sent to the monitoring center 32. In such case, at least one of the first and the second street lamps 300, 302 is determined to operate abnormally.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A street lamp system, comprising:
a monitoring center for sending a monitoring signal;
a first street lamp;
a first sensor configured for detecting an operating state of the first street lamp and generating a first detection signal associated with the operating state;
a first signal receiving unit configured for receiving the monitoring signal;
a first signal sending unit selectively operating in a first power-on state where the first signal sending unit sends a feedback signal to the monitoring center in response to the monitoring signal, or a first power-off state where the first signal sending unit does not send the feedback signal to the monitoring center; and
a first power management unit configured for switching the first signal sending unit to the first power-off state in response to the first detection signal.

2. The street lamp system of claim 1, wherein the first sensor comprises at least one of a thermal sensor and a photo sensor.

3. The street lamp system of claim 1, wherein the first sensor comprises a current sensor.

4. The street lamp system of claim 3, further comprising a plurality of second street lamps, the first and the second street lamps connected in series, and each of the first and the second street lamps connected in parallel to the first sensor.

5. The street lamp system of claim 1, further comprising:
a plurality of second street lamps;
a plurality of second sensors each configured for detecting an operating state of a corresponding second street lamp and thereby generating a second detection signal associated with the operating state;
a plurality of second signal sending units, each of the second signal sending units selectively operating in a second power-on state where the second signal sending unit sends a control signal to the first power management unit, or a second power-off state where the second signal sending unit does not send the control signal to the first power management unit; and
a plurality of second power management units, each of the second power management units configured for switching a corresponding second signal sending unit to the second power-off state in response to the second detection signal.

6. The street lamp system of claim 5, wherein the first power management unit is configured to control the first signal sending unit to operate in the first power-on state when no first detection signal is received, and the second power management unit is configured to control the second signal sending unit to operate in the second power-off state when no second detection signal is received.

7. The street lamp system of claim 5, wherein each of the first and the second sensors comprises at least one of a thermal sensor and a photo sensor.

8. The street lamp system of claim 5, wherein each of the first and the second power management units comprises one of a microcontroller unit and a complex programmable logic device.

9. A street lamp system, comprising:
a monitoring center for sending a monitoring signal;
a first street lamp;
a first sensor configured for detecting an operating state of the first street lamp and generating a first detection signal associated with the operating state;
a first signal receiving unit configured for receiving the monitoring signal;
a first signal sending unit selectively operating in a first power-on state where the first signal sending unit sends a feedback signal to the monitoring center in response to the monitoring signal, or a first power-off state where the first signal sending unit does not send the feedback signal to the monitoring center;
a first power management unit configured for switching the first signal sending unit to the first power-off state in response to the first detection signal; and
a plurality of second street lamps;
a plurality of second sensors each configured for detecting an operating state of a corresponding second street lamp and thereby generating a second detection signal associated with the operating state;
a plurality of second signal sending units, each of the second signal sending units selectively operating in a second power-on state where the second signal sending unit sends a control signal to the first power management unit, or a second power-off state where the second signal sending unit does not send the control signal to the first power management unit;
a plurality of second power management units, each of the second power management units configured for switching a second signal sending unit to the second power-off state in response to the second detection signal.

10. The street lamp system of claim 9, wherein the first power management unit is configured to control the first signal sending unit to operate in the first power-on state when no first detection signal is received, and the second power management unit is configured to control the second signal sending unit to operate in the second power-off state when no second detection signal is received.

11. The street lamp system of claim 9, wherein each of the first and the second sensors comprises at least one of a thermal sensor and a photo sensor.

12. The street lamp system of claim 9, wherein each of the first and the second power management units comprises one of a microcontroller unit and a complex programmable logic device.
